(19) United States
(12) Patent Application Publication
(10) Pub. No.: US 2026/0338622 A1
(43) Pub. Date: Oct. 29, 2026

(54) STACKED THREE-DIMENSIONAL (3D) PRESSURE SENSING DEVICE

(71) Applicant: WUYI UNIVERSITY, Jiangmen (CN)

(72) Inventors: Fei WANG, Jiangmen (CN); Youliang LV, Jiangmen (CN); Jun LI, Jiangmen (CN)

(21) Appl. No.: 19/262,427

(22) Filed: Jul. 8, 2025

(30) Foreign Application Priority Data
Apr. 25, 2025 (CN) 202510528560.2

(51) Int. Cl. G01L 1/18

(52) U.S. Cl. CPC G01L 1/18

(57) ABSTRACT

A stacked three-dimensional (3D) pressure sensing device is disclosed, including: a pressure-sensitive part, an insulating part, and electrodes, where the pressure-sensitive part and the insulating part are in a sheet form, the pressure-sensitive part includes at least two layers of flexible piezoresistive conductive layers stacked together, and the insulating part is sandwiched between every two layers of the flexible piezoresistive conductive layers, the insulating part is made of an insulating elastic deformable material; and a plurality of the electrodes are arranged on a periphery of each layer of the flexible piezoresistive conductive layers, and the electrodes are configured to lead out resistance distribution data from within each layer of the flexible piezoresistive conductive layers through wires.

### CROSS-REFERENCE TO RELATED APPLICATION

This application is based on and claims the benefit of priority from Chinese Patent Application No. 2025105285602, filed on Apr. 25, 2025, the entirety of which is incorporated by reference herein.

### TECHNICAL FIELD

Embodiments of the present disclosure relate to, but are not limited to, the field of pressure sensing technologies, and in particular, to a stacked three-dimensional (3D) pressure sensing device.

### BACKGROUND

In the current era marked by booming development of emerging technologies such as the Internet of Things (IoT), metaverse, smart home and furniture, humanoid robots, and soft robotics, there is an increasingly urgent demand for pressure measurement technologies in human-machine interfaces. These industries require device interfaces to accurately capture pressure changes from users or environmental interfaces, aiming to achieve more natural, safe, and intelligent interactive experiences. For instance, if humanoid robots could be equipped with electronic skin, i.e. tactile sensing capabilities akin to human skin, their interaction abilities with both environments and humans would be significantly enhanced. Existing flexible tactile sensors, such as linear piezoresistive and array-type tactile sensors, have numerous drawbacks, including complex manufacturing processes and wiring, high costs, and limited sensing functionalities. Moreover, when detecting touch positions, magnitudes and spatial distributions of forces (or overall morphology inferred from force), such sensors often fail to achieve multi-dimensional pressure detection, thereby limiting their application scope.

Traditional pressure monitoring technologies employ pressure sensor matrixes for measurement, which exhibit significant limitations. Since each sensor element relies on independent wires for connection, the number of wires in the sensor matrix becomes exceedingly large, which not only increases device complexity and raises costs but also negatively impacts the flexibility, stretchability, and conformability to complex surfaces of the device. If every sensor element in the pressure sensor matrix is upgraded to a 3D pressure sensor, the number of wires per sensor could surge from two to six, eight, or even more, further exacerbating the issues of device complexity and costs, significantly restricting the flexibility and application scenarios of the device.

### SUMMARY

The following is a summary of the subject matters described in detail herein. This summary is not intended to limit the scope of protection of the claims.

Embodiments of the present disclosure provide a stacked 3D pressure sensing device, characterized by a simple structure and being made entirely of flexible materials, requiring arrangement of electrodes and wires only on the periphery, with no internal wires, and being capable of achieving good conformity to curved shapes, enabling a truly smooth touch interface, and possessing a very wide range of 3D pressure measurement and higher sensitivity, thereby improving the sensitivity and range of 3D force measurement.

An embodiment of the present disclosure provides a stacked 3D pressure sensing device, including: a pressure-sensitive part, an insulating part, and an electrode part, where the pressure-sensitive part and the insulating part are in a sheet form, the pressure-sensitive part includes at least two layers of flexible piezoresistive conductive layers stacked together including an upper flexible piezoresistive conductive layer and a lower flexible piezoresistive conductive layer. The insulating part is sandwiched between every two layers of the flexible piezoresistive conductive layers, and the insulating part is made of an insulating elastic deformable material. A plurality of the electrodes are arranged on a periphery of each layer of the flexible piezoresistive conductive layers to form the electrode part, and the electrodes are configured to lead out resistance distribution data from within each layer of the flexible piezoresistive conductive layers through wires to allow a backend circuit device to read in real time the resistance distribution data from within each layer of the flexible piezoresistive conductive layers through electrical impedance tomography, to calculate pressure distribution data at each position on a surface of each layer of the flexible piezoresistive conductive layers at each time point based on the resistance distribution data, and to perform calculations on the pressure distribution data of each layer to obtain 3D pressure distribution information on a surface of the stacked 3D pressure sensing device, where the resistance distribution data includes normal pressure data and shear pressure data, with the normal pressure data at a position under pressure on the surface of all the flexible piezoresistive conductive layers obtained through the pressure distribution data of the upper flexible piezoresistive conductive layers, and the shear pressure data obtained through difference calculations of the pressure distribution data of various layers of the flexible piezoresistive conductive layers.

In some embodiments, the pressure-sensitive part is made of flexible and electrically conductive material in form of a sheet, a film, or a fabric, with each layer of the flexible piezoresistive conductive layers being in a solid planar layer structure, or in a planar mesh structure, or having some areas with holes in the planar mesh structure.

In some embodiments, the insulating part uses an insulating material with elasticity and flexibility, with the insulating part being overall in a sheet form or flat form, and a thickness of the insulating part being maintained at a millimeter or micron level.

In some embodiments, the electrodes are also arranged in a preset region of each layer of the flexible piezoresistive conductive layer according to a preset density.

In some embodiments, the flexible piezoresistive conductive layer uses a conductive composite material, or is a conductor or semiconductor material rich in a conductive ion, or is an assembly of conductive fibers with a piezoresistive property, or is an elastomer containing intrinsically conductive polymers.

In some embodiments, the insulating part uses a polyurethane film or a silicone rubber insulating sheet.

In some embodiments, the electrodes use a coating or plating of a good conductor of electricity, or are micro-nano structured materials, or are carbon-based electrically conductive materials, or are metal-plated fiber materials, or are intrinsically conductive polymers, or are liquid metals.

In some embodiments, the insulating part is placed between every two layers of the flexible piezoresistive conductive layers through a bonding method, the bonding method including any of hot pressing, adhesion, or rolling.

In some embodiments, a surface of the pressure-sensitive part is covered with an encapsulation layer, with an encapsulation material of the encapsulation layer being a flexible polymer elastomer with a low elastic modulus.

In some embodiments, the pressure-sensitive part and the insulating part are prepared using a multi-layer weaving/knitting or 3D weaving/knitting method to create the upper flexible piezoresistive conductive layer and the lower flexible piezoresistive conductive layer each with a piezoresistive effect and an intermediate insulating layer as insulating part, with the upper flexible piezoresistive conductive layer, the lower flexible piezoresistive conductive layer, and the intermediate insulating layer being connected by yarns between the layers, and the wires are embroidered as required on a periphery of the upper and lower flexible piezoresistive conductive layers, with the wires being any of stainless steel fibers, silver-plated nylon yarn, copper-nickel plated nylon yarn, and micron-grade pure copper filaments; or, the pressure-sensitive part and the insulating part are sewn together, with the upper flexible piezoresistive conductive layer, the lower flexible piezoresistive conductive layer, and the intermediate insulating layer sewn together, and silver-plated nylon threads sewn at designated positions on the periphery of each flexible piezoresistive conductive layer.

The embodiments of the present disclosure provide a stacked 3D pressure sensing device, including: a pressure-sensitive part, an insulating part, and electrodes, where the pressure-sensitive part and the insulating part are in a sheet form, the pressure-sensitive part includes at least two layers of flexible piezoresistive conductive layers stacked together, and the insulating part is sandwiched between every two layers of the flexible piezoresistive conductive layers, the insulating part being made of an insulating elastic deformable material; and a plurality of the electrodes are arranged on a periphery of each layer of the flexible piezoresistive conductive layers, and the electrodes are configured to lead out resistance distribution data from within each layer of the flexible piezoresistive conductive layers through wires, allowing a backend circuit device to read in real time the resistance distribution data from within each layer of the flexible piezoresistive conductive layers through electrical impedance tomography, to calculate pressure distribution data at each position on a surface of each layer of the flexible piezoresistive conductive layers at each time point based on the resistance distribution data, and to perform calculations on the pressure distribution data of each layer to obtain 3D pressure distribution information on a surface of the stacked 3D pressure sensing device, where the resistance distribution data includes normal pressure data and shear pressure data, with the normal pressure data at positions under pressure on the surface of all the flexible piezoresistive conductive layers obtained through the pressure distribution data of the first layer (i.e., the upper layer) of the flexible piezoresistive conductive layers, and the shear pressure data obtained through difference calculations of the pressure distribution data of various layers of the flexible piezoresistive conductive layers. The embodiments of the present disclosure use at least two layers of flexible piezoresistive conductive material to form the pressure-sensitive part, the conductive material having piezoresistive properties, meaning that its resistance undergoes predictable changes when subjected to compression or stretching. Therefore, this conductive material is made into sheets to construct planar data of pressure distribution. By stacking two or more sheets of the conductive material, adding a layer of sheet-like insulating elastic material between every two layers of the conductive material, a stacked 3D pressure sensing structure can be formed. A plurality of electrodes are arranged on the periphery of each layer of the conductive material, and the electrodes are configured to connect wires to lead out signals. The method of electrical impedance tomography is used to read the resistance distribution data inside each layer of the flexible conductive material in real time, thereby determining the pressure distribution at various positions on each pressure-sensitive plane. Then, the normal pressure at all positions under pressure is primarily obtained through the first layer of piezoresistive conductive material, while the shear pressure data is acquired through difference calculations of the pressure data from the plurality of layers of piezoresistive conductive material, thereby realizing a fully flexible, inside electrode-free or partially electrode-based, electrical impedance tomography-enabled, multi-point simultaneous detection stacked 3D pressure touch sensing device, which functionally equivalent to a 3D pressure sensor matrix. Based on this, the stacked 3D pressure sensing device according to embodiments of the present disclosure has the advantages of a simple structure and being made entirely of flexible materials, requiring arrangement of electrodes and wires only on the periphery, while having no internal wires, and being capable of achieving good conformity to curved shapes, enabling a truly smooth touch interface, and possessing a very wide range of 3D pressure measurement and higher sensitivity, thereby improving the sensitivity and range of 3D force measurement.

Additional features and advantages of the present disclosure will be set forth in the subsequent description, and in part will become apparent from the description, or may be learned by practice of the present disclosure. The objectives and other advantages of the present disclosure can be realized and obtained by structures specified in the description, the claims and the accompanying drawings.

### BRIEF DESCRIPTION OF DRAWINGS

The accompanying drawings are used to facilitate further understanding of the technical schemes of the present disclosure and constitute a part of the description to explain the technical schemes of the present disclosure together with the embodiments of the present disclosure, and do not constitute a restriction on the technical schemes of the present disclosure.

FIG. 1A depicts a schematic diagram of a top view of a stacked 3D pressure sensing device according to an embodiment of the present disclosure;

FIG. 1B depicts a schematic diagram of a cross-section taken along the dashed line in the top view of FIG. 1A;

FIG. 2 depicts a schematic diagram of a cross-section of a stacked 3D pressure sensing device according to another embodiment of the present disclosure;

FIG. 3 depicts a schematic diagram of a cross-section of a stacked 3D pressure sensing device according to another embodiment of the present disclosure;

FIG. 4A depicts a schematic diagram of a cross-section of a stacked 3D pressure sensing device according to another embodiment of the present disclosure;

FIG. 4B depicts a schematic diagram of an insulating layer in FIG. 4A; and

FIG. 5 depicts a schematic diagram of a cross-section of a stacked 3D pressure sensing device according to another embodiment of the present disclosure.

### DETAILED DESCRIPTION

In order to make the objectives, technical schemes and advantages of the present disclosure clearer, the present disclosure is further described in detail in conjunction with the accompanying drawings and embodiments. It should be understood that the specific embodiments described here are only intended to explain the present disclosure and are not intended to limit the present disclosure.

It should be known that, in the description of the embodiments of the present disclosure, “a plurality of (or multiple)” means two or more; “greater than”, “less than”, “over”, etc. are to be understood to exclude the given figure; and “above”, “below”, “within”, etc. are understood to include the given figure. If there are descriptions using “first”, “second”, etc., they are only for the purpose of distinguishing technical features, and should not be understood as indicating or implying relative importance or implying the number of the indicated technical features or implying the sequence of the indicated technical features.

In the current era marked by booming development of emerging technologies such as the Internet of Things (IoT), metaverse, smart home and furniture, humanoid robots, and soft robotics, there is an increasingly urgent demand for pressure measurement technologies in human-machine interfaces. These industries require device interfaces to accurately capture pressure changes from users or environmental interfaces, aiming to achieve more natural, safe, and intelligent interactive experiences. For instance, if humanoid robots could be equipped with electronic skin, i.e. tactile sensing capabilities akin to human skin, their interaction abilities with both environments and humans would be significantly enhanced. Existing flexible tactile sensors, such as linear piezoresistive and array-type tactile sensors, have numerous drawbacks, including complex manufacturing processes and wiring, high costs, and limited sensing functionalities. Moreover, when detecting touch positions, magnitudes and spatial distributions of forces, such sensors often fail to achieve multi-dimensional pressure detection, thereby limiting their application scope.

Traditional pressure monitoring technologies employ pressure sensor matrixes for measurement, which exhibit significant limitations. Since each sensor element relies on independent wires for connection, the number of wires in the sensor matrix becomes exceedingly large, which not only increases device complexity and raises costs but also negatively impacts the flexibility, stretchability, and conformability to complex surfaces of the device. If every sensor element in the pressure sensor matrix is upgraded to a 3D pressure sensor, the number of wires per sensor could surge from two to six, eight, or even more, further exacerbating the issues of device complexity and costs, significantly restricting the flexibility and application scenarios of the device.

To solve the above technical problem, an embodiment of the present disclosure provides a stacked 3D pressure sensing device, including: a pressure-sensitive part, an insulating part, and electrodes, where both the pressure-sensitive part and the insulating part are in a sheet form, the pressure-sensitive part is composed of at least two layers of flexible piezoresistive conductive layers stacked together, and the insulating part is sandwiched between every two layers of the flexible piezoresistive conductive layers, and the insulating part is made of an insulating elastic deformable material. A plurality of the electrodes are arranged on a periphery of each layer of the flexible piezoresistive conductive layers, and the electrodes are configured to lead out resistance distribution data from within each layer of the flexible piezoresistive conductive layers through wires, allowing a backend circuit device to read in real time the resistance distribution data from within each layer of the flexible piezoresistive conductive layers through electrical impedance tomography, calculate pressure distribution data at each position on a surface of each layer of the flexible piezoresistive conductive layers at each time point based on the resistance distribution data, and then perform calculations on the pressure distribution data of each layer to obtain 3D pressure distribution information on a surface of the stacked 3D pressure sensing device, where the resistance distribution data includes normal pressure data and shear pressure data, with the normal pressure data at positions under pressure on the surface of all the flexible piezoresistive conductive layers obtained through the pressure distribution data of the first layer (i.e., the upper layer) of the flexible piezoresistive conductive layers, and the shear pressure data obtained through difference calculations of the pressure distribution data of a plurality of layers of the flexible piezoresistive conductive layers. The embodiments according to the present disclosure employ at least two layers of flexible piezoresistive conductive material to form the pressure-sensitive part, the conductive material having piezoresistive properties, meaning that its resistance undergoes predictable changes when subjected to compression or stretching. Therefore, this conductive material is made into sheets to construct planar data of pressure distribution. By stacking two or more sheets of the conductive material, adding a layer of sheet-like insulating elastic material between every two layers of the conductive material, a stacked 3D pressure sensing structure can be formed. A plurality of electrodes are arranged on the periphery of each layer of the conductive material, and the electrodes are configured to connect wires to lead out signals. The method of electrical impedance tomography is used to read the resistance distribution data inside each layer of the flexible conductive material in real time, thereby determining the pressure distribution at various positions on each pressure-sensitive plane. Then, the normal pressure at all positions under pressure is primarily obtained through the first layer of piezoresistive conductive material, while the shear pressure data is acquired through difference calculations of the pressure data from the plurality of layers of piezoresistive conductive material, thereby realizing a fully flexible, inside electrode-free or partially electrode-based, electrical impedance tomography-enabled, multi-point simultaneous detection stacked 3D pressure touch sensing device, which functionally equivalent to a 3D pressure sensor matrix. Based on this, the stacked 3D pressure sensing device according to the present disclosure has the advantages of a simple structure and being made entirely of flexible materials, requiring arrangement of electrodes and wires only on the periphery, while having no internal wires, and being capable of achieving good conformity to curved shapes, enabling a truly smooth touch interface, and possessing a very wide range of 3D pressure measurement and higher sensitivity, thereby improving the sensitivity and range of 3D force measurement.

The stacked 3D pressure sensing device according to embodiments of the present disclosure consists of three parts, including: a pressure-sensitive part, an insulating part, and electrodes.

It can be understood that the pressure-sensitive part includes at least two layers of flexible piezoresistive conductive layers, with the flexible piezoresistive conductive layers being made of piezoresistive conductive materials, and electrodes being arranged on the periphery of each flexible piezoresistive conductive layer. By using electrical impedance tomography to monitor in real time the resistance distribution of each layer of the flexible piezoresistive conductive layers, the pressure distribution information at each position on the surface of the flexible piezoresistive conductive layers of different sensing layers of the device can be calculated at each time point. Then, calculations are performed on the data of each layer of the flexible piezoresistive conductive layers to obtain the overall 3D pressure distribution information experienced by the device.

It can be understood that both the pressure-sensitive part and the insulating part according to embodiments of the present disclosure are in a sheet form, which can realistically simulate the smooth state of human skin surface, therefore, good conformity to curved shapes can be achieved, enabling a truly smooth touch interface.

It can be understood that three-dimensional force is measured through at least two layers of piezoresistive conductive material in the present disclosure. In this way, when there is shear force, the application of shear force along an in-plane direction will cause in-plane displacement of the force application positions in each layer of material. The in-plane displacement of the upper layer of material is obviously the largest, followed by the second layer of material, and then the third layer. This is due to the fact that elastic materials with a certain thickness can disperse the surface stress. Therefore, the further down the layers, the larger the projected area of the 3D force that is transmitted, the more the projected stress diminishes, and the slower the projected in-plane displacement becomes. That is, this causes misalignment of pressure at each layer. Therefore, the mapping of three-dimensional forces in different layers of piezoresistive material will result in different two-dimensional topological patterns. By comparing the differences in the distribution of piezoresistive data between different layers, the magnitude and direction of the three-dimensional pressure can be inferred. Based on this method, which is somewhat similar to computed tomography technology, the mapping of the 3D force information on each layer is first captured, and then the data from all layers is merged for calculation to reconstruct the entire 3D pressure distribution data.

It should be noted that for the calibration of the stacked 3D pressure sensing device, due to individual material differences and slight variations in assembly processes, initial measurements of the device may have deviations. Using a standard pressure generating device, known pressures are applied to the device at multiple pressure angles and with different pressure amplitudes. The output data of the device is collected and compared and the backend circuit parameters are precisely calibrated, so as to enable the stacked 3D pressure sensing device to accurately reflect the real pressure conditions.

It can be understood that the pressure-sensitive part is made of flexible and electrically conductive material in the form of sheets, films, or fabrics, with each layer of the conductive material presenting a solid planar layer structure, or it may be a planar mesh structure, which means that some areas contain holes. This type of flexible and electrically conductive material has a pressure-sensitive property/a piezoresistive property, namely that when subjected to pressure, the resistance at corresponding positions will change. Additionally, it is acceptable even if the material is not a conventional piezoresistive material, as long as the resistance at the position under pressure can exhibit predictable and repeatable changes under pressure.

It can be understood that, in some embodiments, the insulating part is made of insulating materials with excellent elasticity and flexibility, with this insulating part being overall in a sheet form or flat form, and the thickness is maintained at a millimeter or micron level to ensure effective isolation without occupying excessive space. Its texture is uniform, and it can also be a planar mesh structure, meaning that some areas contain holes, but it is essential to ensure that each area can stably perform insulation functions, preventing any unexpected conduction between the conductive materials of different layers in the pressure-sensitive part. The sheet-like insulating material can be tightly bonded with the upper and lower flexible and electrically conductive materials, and during various deformations such as compression, bending, and twisting of the device, the insulating material exhibits resistance to damage, maintaining a reliable insulating barrier for the stable operation of the entire sensing device. Therefore, whether in static placement or dynamic usage scenarios, the insulating part can consistently maintain good insulation performance.

It can be understood that the electrodes can be evenly arranged on the periphery of each pressure-sensitive layer. In other words, the electrodes can be spaced apart from each other at equal intervals. Alternatively, the density of electrodes can be adjusted according to the requirements for resolution and precision at different positions. In addition to arranging the electrodes on the periphery of the device, electrodes can also be selectively added at various different positions beneath the pressure-sensitive material to significantly enhance the positional accuracy and pressure accuracy during measurements of the sensor. Under the same backend processing circuit and algorithm framework, the electrode layout acts like a “precision and accuracy adjustment valve.” With an increase in the number of electrodes and optimized distribution, the information obtained from electrical impedance tomography becomes richer, thereby synchronously improving the accuracy of normal pressure measurement, shear force resolution, and position recognition precision.

It can be understood that, in some embodiments, the material of the pressure-sensitive part is selected from electrically conductive composite materials. To strengthen the piezoresistive properties, the resistance (or electrical resistivity) of these conductive materials should preferably be in the range of the semiconductor material. In some implementations, the pressure-sensitive part is made of a pressure-sensitive rubber material, a graphene/silicone composite material, a multi-arm carbon nanotube/polyurethane composite material, and/or the like. The material of the pressure-sensitive part may also be conductors and semiconductors with a certain degree of fluidity, such as gallium-indium alloys or gels and liquids rich in conductive ions. An assembly of electrically conductive fibers with piezoresistive properties may also be used as the material for the pressure-sensitive part, such as pure cotton knitted fabrics with graphene and carbon nanotubes attached to the surface, or a spandex warp-knitted mesh fully coated with carbon black/polyurethane composite material prepared using screen printing technology. Additionally, elastomers containing intrinsically conductive polymers, for example, composite films of polypyrrole and polyurethane, are also included in the optional range. In summary, a sheet-like material with elasticity and being continuously conductive, whether it is a sheet-like mesoporous or sheet-like solid material, meets the usage conditions of the pressure-sensitive part according to embodiments of the present disclosure, as long as the resistance at the position under pressure produces repeatable and predictable changes when pressure is applied. The pressure-sensitive part can be designed as a flat planar structure or with protrusions according to requirements.

It can be understood that the material of the insulating part emphasizes excellent flexibility and outstanding insulation performance. Common examples include polyurethane films or silicone rubber insulating sheets, which are all very soft, have good elasticity and strong plasticity, and can easily adapt to different shapes of component structures, ensuring a tight fit and preventing conductive parts from having opportunities to “cross over.” The material of the insulating part is mostly in the form of thin sheets, with thickness precisely controlled to prevent leakage, short circuits, while not hindering the compact assembly of the entire device. The insulating part is seamlessly attached to the adjacent pressure-sensitive part, ensuring that the device maintains consistent insulation effectiveness against both minor daily vibrations and frequent deformations during long-term use, and remaining stable and durable.

It can be understood that the material of the electrode part may be a coating or plating of a good conductor of electricity such as gold, silver, or copper, or a micro-nano structured material (such as silver nanowires/silicone composite materials, or silver powder particles/epoxy resin composite materials), or a carbon-based electrically conductive material (such as carbon fibers), or a coated metal fiber material, or an intrinsically conductive polymer (such as poly(3,4-ethylenedioxythiophene)-polystyrene sulfonate), or a liquid metal (such as gallium-indium alloy).

It can be understood that the insulating flexible film can be placed between two layers of the flexible and electrically conductive material, and methods such as hot pressing, adhesion, or rolling may be used to ensure accurate bonding without wrinkles or bubble residues. The electrode layer may be arranged either before or after bonding, using high-precision processes such as screen printing or chemical vapor deposition by attaching electrode materials at specified electrode points according to different requirements at positions; or by applying silver paste resin or using silver-plated nylon yarns to embroider electrodes and other such simple processes. After the attachment of the electrodes is completed, the connecting wires can be connected to the backend circuit. For some special designs, if additional mechanical transmission reinforcement structures need to be added, although no separate transmission part is set, similar functions can be achieved with external accessories. In an example, silicone or rubber blocks with moderate hardness and matching shapes are used and adhered to the corresponding sites on the surface of the pressure-sensitive part using a glue dispensing machine; or 3D printing is used to customize 3D structures, which is then adhered to key points under pressure beneath the pressure-sensitive material to assist in more efficient pressure transmission to the pressure-sensitive par. Electrodes and wires are connected after assembly.

It can be understood that, in some embodiments, an encapsulation layer covers the upper and lower surfaces of the device, especially the pressure-sensitive part and the critical areas that may come into contact with a pressure source. In some implementations, a flexible polymer elastomer with a low elastic modulus is selected, which can protect the internal flexible and electrically conductive materials and insulating films from moisture and dust erosion, and can also promote uniform pressure dispersion at the moment of pressure contact, avoiding localized stress concentration that could damage the device, ensuring stable operation and maintaining measurement accuracy. The encapsulation layer can also be configured to make the uneven surface of the pressure-sensitive layer smooth.

It can be understood that the 3D elasticity of the pressure-sensitive part and the insulating part lays the foundation for the adaptability of the device. Outstanding 3D elasticity enables the device to break through planar limitations, conforming to spherical and irregular curved surfaces, such as fitting onto joint areas of smart prosthetics, where even when stretched and deformed, after calibration, the device can still capture complete and accurate 3D pressure information, greatly enriching the application scenarios. The piezoresistive properties of pressure-sensitive materials are the key to sensitivity; under the same conditions, the more significant the piezoresistive effect, the more sensitive the device is to detecting minor pressures. At the same time, the size and stiffness of the pressure-sensitive part jointly affect the measurement range and sensitivity. Although a large size combined with high stiffness results in a strong stress concentration effect and improved sensitivity, the measurable upper limit of force may become constrained. Variations in the number, distribution, and density of auxiliary transmission structures with different layouts can also alter the pressure transmission effects to varying degrees, and thus the measurement range and accuracy of 3D force measurement can be adjusted.

It can be understood that instead of using the claimed polymer films or sheet materials mentioned above for preparation, fiber materials and textile processes can also be fully or partially employed to process the stacked 3D pressure sensing device, such as using multilayer weaving/knitting and 3D weaving/knitting to prepare the upper pressure-sensitive layer, lower pressure-sensitive layer, and intermediate insulating layer with piezoresistive effects in one go, with layers connected by yarns. Finally, wires are formed by embroidering on the periphery of the upper and lower pressure-sensitive layers as needed, preferably using stainless steel fibers, silver-plated nylon yarns, copper-nickel plated nylon yarns, and micron-level pure copper filaments. Alternatively, sewing methods may be used to stitch together the upper piezoresistive fabric layer, the lower piezoresistive fabric layer, and the intermediate insulating fabric layer, with silver-plated nylon threads sewn at designated positions on the periphery of each piezoresistive fabric layer.

Based on this, the stacked 3D pressure sensing device according to embodiments of the present disclosure is mainly composed of elastic materials and is divided into three parts according to function: a pressure-sensitive part, an insulating part, and electrodes. The pressure-sensitive part is made of flexible and electrically conductive material, which has piezoresistive properties, meaning that its resistance changes in a predictable manner when compressed or stretched. Therefore, this conductive material is made into a sheet form (or called a film) to construct planar data of pressure distribution. By stacking two or more sheets of the conductive material, adding a layer of sheet-like insulating elastic material between every two layers of the conductive material, a stacked 3D pressure sensing structure can be formed. A plurality of electrodes are arranged on the periphery of each layer of the conductive material, and the electrodes are configured to connect wires to lead out signals. The method of electrical impedance tomography is employed to read the resistance distribution data inside each layer of the flexible conductive material in real time, thereby determining the pressure distribution at various positions on each pressure-sensitive plane. Then, the normal pressure at all positions under pressure is primarily obtained through the first layer of piezoresistive conductive material, while the shear pressure data is acquired through difference calculations of the pressure data from the plurality of layers of piezoresistive conductive material, thereby realizing a fully flexible, inside electrode-free or partially electrode-based, electrical impedance tomography-enabled, multi-point simultaneous detection stacked 3D pressure touch sensing device, which functionally equivalent to a 3D pressure sensor array.

In summary, the embodiments of the present disclosure provide a 3D pressure sensing device with a simple structure, low cost, easy processing, made entirely of flexible materials, requiring only peripheral electrodes and wires, and having no internal wires, while also exhibiting good conformity to curved shapes. The device adopts a multi-layer stacked structure, with a smooth surface, is capable of addressing the measurement workload range for large pressure, medium pressure, and small pressure, and can detect 3D pressure with high sensitivity.

The embodiments of the present disclosure will be further explained below with reference to the accompanying drawings.

### Example Embodiment I

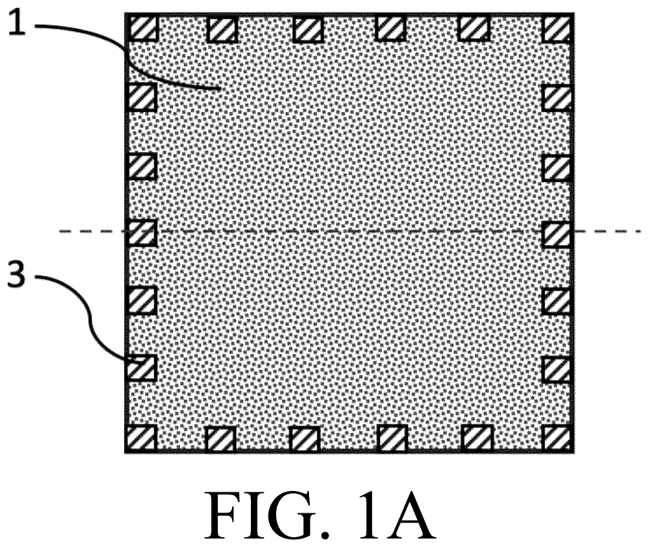

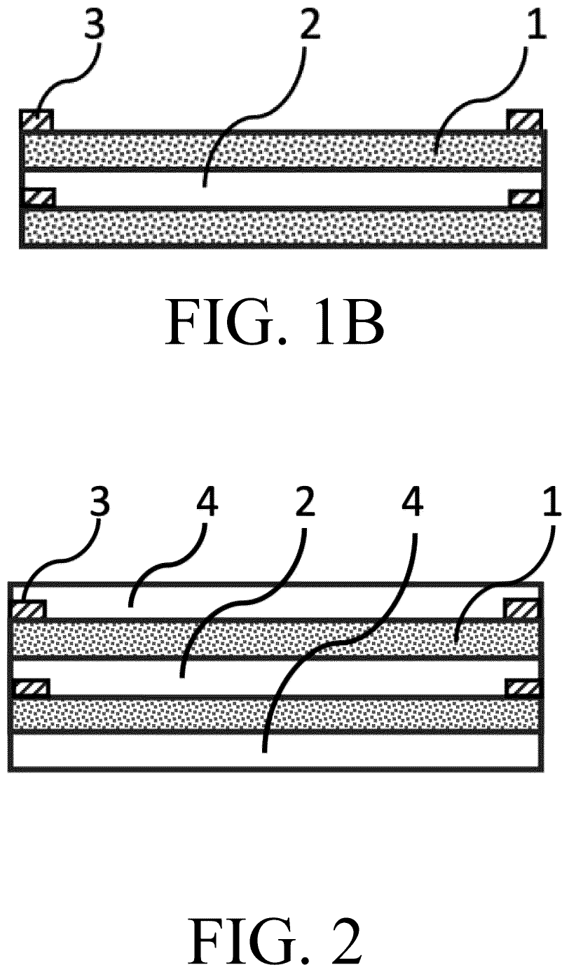

Referring to FIGS. 1A and 1B, this embodiment provides a stacked flexible 3D pressure sensing device, the device including three parts: a pressure-sensitive part 1, an insulating part 2, and an electrode part 3. The pressure-sensitive part 1 uses silicone rubber filled with graphene and carbon nanotubes, with the filling of electrically conductive particles imparting piezoresistive properties. When a certain portion is subjected to pressure, the resistance of that portion will change in a predictable manner. The upper and lower layers of such flexible and electrically conductive material are the key to the entire measurement. Under the action of external 3D multi-point pressure, the resistance changes at different positions carry the pressure information of those positions, providing foundational data support for subsequent calculations of 3D pressure distribution. Excellent silicone material with flexibility and insulation is used as insulating part 2, which is overall in a sheet form, preferably with a thickness at the millimeter level. By using processes such as hot pressing, vacuum, and rolling, the insulating part 2 is securely placed between the upper and lower layers of pressure-sensitive part 1, ensuring tight attachment, eliminating gaps and bubbles, and effectively preventing accidental conduction between the two layers of conductive materials. Under various deformation conditions such as pressure and bending, the insulating part 2 can maintain a stable insulation effect, ensuring that measurements are not interfered with. The electrode part 3 is made of a composite material of silver nanowires and silicone rubber. First, a dispersion of silver nanowires in ethanol is applied at the electrode position, and after the ethanol evaporates, a small amount of silicone is added to form it. Thanks to the silicone rubber component, a strong bond can be formed with the pressure-sensitive part 1, in which the silver nanowires also achieve a reliable electrical connection of the electrode part 3 with the pressure-sensitive part 1. Electrodes are uniformly arranged on the periphery of the device, with the ability to be spaced evenly to meet basic measurement requirements, while also allowing for flexible adjustment of electrode density according to the precision requirements at different positions.

During operation, due to the piezoresistive properties of the pressure-sensitive part 1, the pressure will cause different resistance changes in the upper and lower layers of conductive material. By sequentially applying current to the electrodes on the periphery of the device and synchronously measuring the voltage distribution of the remaining electrodes, the method of electrical impedance tomography can be used to read the real-time distribution of resistance of the two layers of pressure-sensitive materials. By performing difference calculations on the resistance distribution data corresponding to the two layers of materials, the 3D pressure distribution at various positions on the surface of the device can be accurately inferred.

The electrodes are arranged only on the periphery of the device, which greatly reduces the number of wires required compared to traditional 3D pressure sensor matrixes, and avoids reliance on stretchable wire technology when making an overall stretchable flexible device, reaching a prominent practicality. Moreover, this embodiment achieves real-time monitoring of 3D pressure at multiple points within a plane. Compared to the single position identification function of inductive or capacitive pressure touch panels, and the single normal pressure measurement function of conventional electrical impedance tomography, the device can provide the distribution of shear forces at multiple points, demonstrating significant inventiveness.

### (1) A First Variant of Example Embodiment I

Referring to FIG. 2, based on the aforementioned device architecture, this embodiment further has an optional configuration: an encapsulation layer 4. By employing a casting process, a layer of silicone rubber is uniformly applied to cover the entire surface of the device, and an additional layer is similarly applied to the lower surface. Through this treatment, the surfaces of the device achieve a smooth and flat finish, providing electrical insulation, aesthetic enhancement, and protective functions. In terms of material selection, silicone rubber material of the same type as the pressure-sensitive part (layer) 1 is suitable, or silicone rubber material with a lower elastic modulus than the pressure-sensitive part 1 can also be selected as the encapsulation layer 4. Thus, when external pressure is applied to the surface of the encapsulated device, the normal pressure and lateral shear forces at each position can be transmitted unobstructedly and efficiently, maximizing the effectiveness and stability of pressure transmission, maintaining the measurement accuracy of the device.

### (2) A Second Variant of Example Embodiment I

In an embodiment, referring to FIG. 2, to achieve measurements of minor pressure, the pressure-sensitive part 1 may also use a composite structure of polyurethane foam and ionic liquid. Polyurethane foam has a unique 3D porous structure, with abundant and interconnected pores that provide a smooth pathway for the movement of ions. Ionic liquid is filled within these pores, rich in various ions (for example, cations and anions in imidazolium ionic liquids), and possesses good conductivity. When external pressure is applied, the pores of polyurethane foam undergo deformation, compressing or stretching the ionic liquid within, resulting in changes to the distribution density and movement pathways of the ions, which in turn causes a significant change in resistance. This composite structure has a low overall elastic modulus, is sensitive to minor pressure, and can accurately capture even the slightest external force touch, and convert it into a measurable resistance signal. In conjunction with the pressure-sensitive part 1, the insulating part 2 also adopts a polyurethane foam structure, and the encapsulation layer 4 also uses polyurethane foam, allowing such a stacked device to achieve measurements of 3D minor pressure.

The stacked flexible device of this embodiment variant demonstrates advantages in the field of micro pressure detection due to its unique structure and material application, making it particularly suitable for scenarios that require strict sensitivity to minor pressure, such as micro force monitoring during the assembly of high-precision electronic components and biomechanical research of biological tissues, thereby expanding the application landscape of flexible 3D pressure sensing devices.

### Example Embodiment II

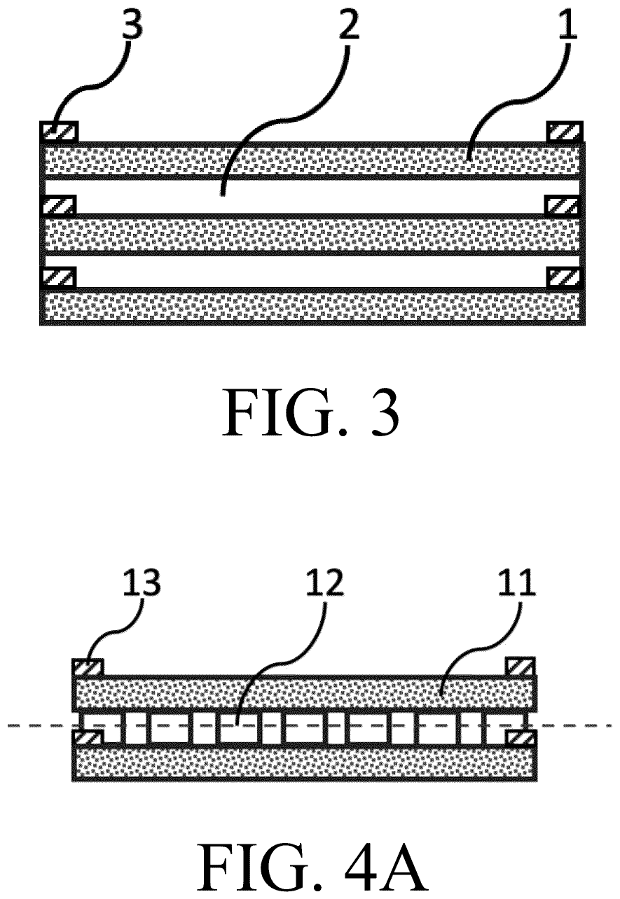

Referring to FIG. 3, this embodiment provides a stacked flexible 3D pressure sensing device containing three pressure-sensitive layers, the device including three parts: a pressure-sensitive part 1, an insulating part 2, and an electrode part 3. Differing from Example Embodiment I, in this embodiment, the pressure-sensitive part 1 has a total of three layers, referred to from top to bottom as an upper pressure-sensitive part 1, an intermediate pressure-sensitive part 1, and a lower pressure-sensitive part 1, while the insulating part 2 has a total of two layers, referred to from top to bottom as a first insulating layer and a second insulating layer. The embodiment can preferably adjust the thickness and elastic modulus of the first insulating layer and the second insulating layer, for instance, the elastic modulus of the first insulating layer is ⅕ of the elastic modulus of the second insulating layer, while the thickness of the first insulating layer and the thickness of the second insulating layer are the same. In this way, the shear force applied to the surface of the upper pressure-sensitive part 1 will more easily cause the sliding of the upper pressure-sensitive part 1, while relatively not easily causing the sliding of the intermediate pressure-sensitive part 1. Therefore, the difference in tangential pressure distribution data between the upper pressure-sensitive part 1 and the intermediate pressure-sensitive part 1 will be larger, while the difference in tangential pressure distribution data between the intermediate pressure-sensitive part 1 and the lower pressure-sensitive part 1 will be smaller. The benefit of this design is that the upper and intermediate pressure-sensitive parts are more easily able to measure small shear forces, while the intermediate and lower pressure-sensitive parts are more easily able to measure larger shear forces. Through such functional zoning, the overall measurement range of shear forces in the device can be effectively improved, allowing the device to be sensitive to both small pressure and shear forces as well as larger pressure and shear forces. Of course, to further expand the pressure measurement range of the device, more layers of pressure-sensitive layers can also be designed, all of which fall within the scope of protection of the present disclosure. It should also be noted that the materials of each layer of pressure-sensitive part can be adjusted as needed, and it is not necessary to use the same materials and proportions. For example, for measurements of small pressures, a pressure-sensitive part 1 with a relatively high sensitivity is needed, while for measurements of larger pressures, a pressure-sensitive part 1 with a relatively low sensitivity is required.

### Example Embodiment III

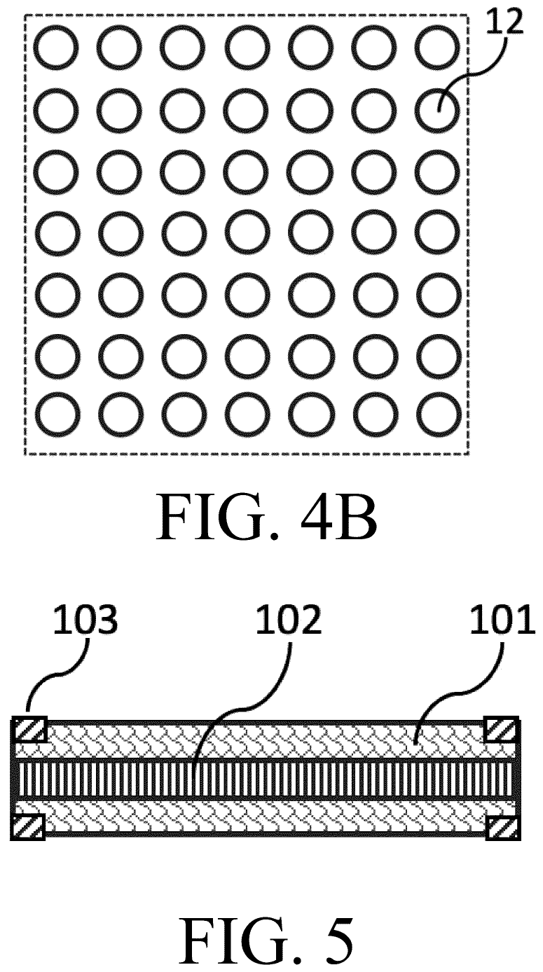

Referring to FIG. 4, this embodiment shows a stacked fully flexible 3D pressure sensing device with multi-point support. Differing from Example Embodiment I, the intermediate insulating layer 12 adopts a non-continuous lattice arrangement, with each insulating unit shown in FIG. 4 being a cylinder that connects the upper and lower pressure-sensitive layers. Compared to solid materials, the non-continuous lattice insulator arrangement can effectively reduce the overall stiffness of the insulating layer, thus greatly increasing the displacement of the upper pressure-sensitive layer under shear force, allowing for higher sensitivity in shear force measurements. Each unit of the insulator may be a cylinder or other solid shapes, such as thin cylinders, frustums, triangular pyramids, cones, truncated triangular pyramids, and truncated frustums. That is, in addition to the ability to adjust the sensitivity and working range of pressure measurement through parameters such as thickness and elastic modulus as described in Example Embodiment II, the design of shape parameters of the insulating layer can further enhance the displacement between layers under shear force, thereby improving force sensing sensitivity.

### Example Embodiment IV

The embodiments described above are all solid structures; however, non-solid materials may also be used. A typical example is the structure of textiles. Referring to FIG. 5, a pressure-sensitive part 101 is made from raw materials of carbon black/polyurethane fibers, while an insulating part 102 uses polyurethane fibers. The upper and lower layers of the pressure-sensitive part 101 and the insulating part 102 are woven in one go using a textile 3D weaving method, and an electrode part 103 is formed by embroidering with silver-plated nylon yarns at designated positions on the periphery of the pressure-sensitive part 101. The carbon black/polyurethane composite material itself has certain inherent piezoresistive properties, so this fabric can be employed to measure pressure by means of electrical impedance tomography. More importantly, since all raw materials are woven with elastic yarns, the prepared stacked device has multi-directional stretchability and large deformation capability. Therefore, this textile device can not only measure multi-point 3D pressure on flat surfaces but can also cover curved surfaces with different curvatures, such as fitting to the arms, palms, and fingers of robots, providing the robot with a fully skin-like 3D pressure sensing surface.

Based on the above, compared to the existing technologies, the stacked 3D pressure sensing device according to embodiments of the present disclosure has at least the following beneficial effects:
(1) A smooth device surface, high sensitivity, and a wide pressure measurement range can be achieved. The present disclosure adopts a multi-layer stacked structure, which can address the measurement workload range for large pressure, medium pressure, and small pressure, and can also improve the sensitivity of pressure measurement through the parameters of the insulating layer. The present disclosure provides a stacked pressure sensing device that enables the inside detection portion in the device to not require wires, with the inside detection portion made of an elastic body with high stretchability, having a smooth surface and capabilities of high sensitivity detection of 3D pressure, and providing full coverage for large, medium, and small pressures simultaneously.
(2) 3D force: The present disclosure is capable of achieving multifunctional detection of the touch position, the magnitude and direction of the pressure at each touch position, as well as the overall spatial distribution of the touch pressure, greatly enhancing the sensing capability of the sensor. In particular, the sensing of 3D forces can provide richer information compared to the sensing of pure normal pressure.
(3) Simple structure and process: Compared with the pressure sensor matrix, the present disclosure adopts an integrated structure, eliminating the need for complex internal microstructures and wiring, thereby reducing manufacturing difficulty and costs.
(4) Flexible and stretchable: The sensor materials are low-cost and flexible, possessing inherent flexibility and stretchability without the use of stretchable wires. It can easily cover surfaces of various irregular 3D objects for comprehensive tactile coverage and sensing, enhancing the applicability and practicality of the sensor.
(5) Textile characteristics: When a flexible 3D force sensing device is made of textile materials, it also possesses various advantages of textiles and garment products, including being skin-friendly, comfortable, breathable, porous, lightweight, machine washable, dryable, etc., thus allowing for perfect integration with various textiles and garment products.

The above is a detailed description of some implementations of the present disclosure, but the present disclosure is not limited to the above-mentioned embodiments. Those of ordinary skill in the art can also make various equivalent modifications or replacements without departing from the gist of the present disclosure, and these equivalent modifications or replacements are all included in the scope defined by the claims of the present disclosure.

What is claimed is:

1. A stacked three-dimensional (3D) pressure sensing device, comprising: a pressure-sensitive part, an insulating part, and an electrode part, wherein the pressure-sensitive part and the insulating part are in a sheet form, the pressure-sensitive part comprises at least two layers of flexible piezoresistive conductive layer stacked together, comprising at least an upper flexible piezoresistive conductive layer and a lower flexible piezoresistive conductive layer, and the insulating part is sandwiched between every two layers of the at least two layers of flexible piezoresistive conductive layer, the insulating part is made of an insulating elastic deformable material; and a plurality of the electrodes are arranged on a periphery of each layer of the at least two layers of flexible piezoresistive conductive layer to form the electrode part, and each of the plurality of electrodes is configured to lead out resistance distribution data from within each layer of the flexible piezoresistive conductive layers through a wire to allow a backend circuit device to read in real time the resistance distribution data from within each layer of the flexible piezoresistive conductive layers through electrical impedance tomography, to calculate pressure distribution data at each position on a surface of each layer of the flexible piezoresistive conductive layers at each time point based on the resistance distribution data, and to perform a calculation on the pressure distribution data for each layer to obtain 3D pressure distribution information on a surface of the stacked 3D pressure sensing device, wherein the resistance distribution data comprises normal pressure data and shear pressure data, with the normal pressure data at a position under pressure on the surface of the stacked 3D pressure sensing device obtained through the pressure distribution data of the upper flexible piezoresistive conductive layer, and the shear pressure data obtained through a difference calculation of the pressure distribution data of various layers of the at least two layers of flexible piezoresistive conductive layers.

2. The stacked 3D pressure sensing device of claim 1, wherein the pressure-sensitive part is made of flexible and electrically conductive material in form of a sheet, a film, or a fabric, with each layer of the flexible piezoresistive conductive layers being in a solid planar layer structure, or in a planar mesh structure, or having several areas with holes in the planar mesh structure.

3. The stacked 3D pressure sensing device of claim 1, wherein the insulating part uses an insulating material with elasticity and flexibility, with the insulating part being overall in a sheet form or a flat form, and a thickness of the insulating part being maintained at a millimeter or a micronmeter level.

4. The stacked 3D pressure sensing device of claim 1, wherein the plurality of electrodes are also arranged in a preset region of each layer of the flexible piezoresistive conductive layer according to a preset density.

5. The stacked 3D pressure sensing device of claim 1, wherein the flexible piezoresistive conductive layer uses a conductive composite material, or is a conductor or semiconductor material rich in a conductive ion, or is an assembly of conductive fibers with a piezoresistive property, or is an elastomer containing an intrinsically conductive polymer.

6. The stacked 3D pressure sensing device of claim 1, wherein the insulating part uses a polyurethane film or a silicone rubber insulating sheet.

7. The stacked 3D pressure sensing device of claim 1, wherein each of the plurality of electrodes uses a coating or plating of a good conductor of electricity, or is a micro-nano structured material, or is a carbon-based electrically conductive material, or is a metal-plated fiber material, or is an intrinsically conductive polymer, or is a liquid metal.

8. The stacked 3D pressure sensing device of claim 1, wherein the insulating part is sandwiched between every two layers of the at least two layers of the flexible piezoresistive conductive layers through a bonding method, wherein the bonding method comprises any of hot pressing, adhesion, or rolling.

9. The stacked 3D pressure sensing device of claim 1, wherein a surface of the pressure-sensitive part is covered with an encapsulation layer, with an encapsulation material of the encapsulation layer being a flexible polymer elastomer with a low elastic modulus.

10. The stacked 3D pressure sensing device of claim 1, wherein the pressure-sensitive part and the insulating part are prepared using a multi-layer weaving/knitting or 3D weaving/knitting method to create the upper flexible piezoresistive conductive layer and the lower flexible piezoresistive conductive layer each with a piezoresistive effect and an intermediate insulating layer as the insulating part, wherein the upper flexible piezoresistive conductive layer, the lower flexible piezoresistive conductive layer, and the intermediate insulating layer are connected by yarns between the layers, and the wire is embroidered as required on a periphery of the upper flexible piezoresistive conductive layer and the lower flexible piezoresistive conductive layer, with the wire being any of a stainless steel fiber, a silver-plated nylon yarn, a copper-nickel plated nylon yarn, and a micron-grade pure copper filament; or, the pressure-sensitive part and the insulating part are sewn together, with the upper flexible piezoresistive conductive layer, the lower flexible piezoresistive conductive layer, and the intermediate insulating layer sewn together, and a silver-plated nylon thread sewn at a designated position on the periphery of each layer of flexible piezoresistive conductive layer.
